(19) United States
(12) Patent Application Publication
(10) Pub. No.: US 2023/0094060 A1
(43) Pub. Date: Mar. 30, 2023

(54) RECOVERY METHOD AND RECOVERY SYSTEM

(71) Applicant: KABUSHIKI KAISHA TOYOTA CHUO KENKYUSHO, Nagakute-shi (JP)

(72) Inventors: Nobuhiro OGIHARA, Nagakute-shi (JP); Shogo KOMAGATA, Nagakute-shi (JP); Takahiro HORIBA, Nagakute-shi (JP)

(73) Assignee: KABUSHIKI KAISHA TOYOTA CHUO KENKYUSHO, Nagakute-shi (JP)

(21) Appl. No.: 17/875,600

(22) Filed: Jul. 28, 2022

(30) Foreign Application Priority Data
Aug. 26, 2021 (JP) 2021-137686

(51) Int. Cl. H01M 4/134; H01M 10/0525; H01M 10/0569

(52) U.S. Cl. CPC H01M 4/134; H01M 10/0525; H01M 10/0569; H01M 2300/0045

(57) ABSTRACT

A recovery method according to the present disclosure is a recovery method for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent. The recovery method includes an electrode recovery step of immersing the electrode of the electricity storage device in a recovery agent to recover the capacity of the electrode active material while maintaining the state of the electrode, the recovery agent being a solution containing an aromatic hydrocarbon compound in a reduced state, a metal ion of the same type as the carrier ion, a recovery agent solvent of an ether compound different from the electrolyte solvent, and an electrolyte solution.

### BACKGROUND OF THE INVENTION

### 1. Field of the Invention

The present specification discloses a recovery method and a recovery system.

### 2. Description of the Related Art

A proposed method for recycling a lithium-ion secondary battery includes immersing a used secondary battery in a molten salt, extracting molten metal melted in the molten salt, and recovering ions dissolved in the molten salt by molten salt electrolysis, wherein the molten salt has a composition with a smaller specific gravity than the molten metal (for example, see Patent Literature 1). Also proposed is a method including a precipitation step for Co recovery of performing a wet process on a waste containing a positive-electrode material, extracting cobalt ions by solvent extraction from an acidic solution containing cobalt ions, nickel ions, and impurities, performing back extraction, extracting cobalt ions by solvent extraction from the back-extracted liquid produced in the previous step, performing back extraction, adding oxalic acid to the back-extracted liquid produced in the second extraction step, and collecting a precipitate containing an oxalate (for example, see Patent Literature 2). It is stated that this method can effectively remove specified impurities. It has also been proposed that a solution containing lithium ions is supplied to and brought into contact with a strongly acidic cation-exchange resin having a sodium sulfonate group as a functional group to allow the lithium ions to be adsorbed on the strongly acidic cation-exchange resin, and the ion-exchange resin is supplied to and brought into contact with an eluent containing a sodium salt to elute the lithium ions adsorbed on the strongly acidic cation-exchange resin (for example, see Patent Literature 3). It is stated that this method can elute and recover lithium at a high elution rate while reducing the cost of chemical agents. It has also been proposed that a used lithium-ion battery is ground and sieved into a finely ground product composed mainly of an electrode active material and a coarsely ground product larger than the finely ground product, the finely ground product is recovered, water is added to the finely ground product to prepare a suspension slurry, a surfactant is added to the suspension slurry to separate and disperse carbon of a negative-electrode active material and a finely ground product derived from a positive-electrode active material, and the finely ground product derived from the positive-electrode active material contained in the suspension slurry is magnetically adsorbed to selectively separate and recover the finely ground product from the suspension slurry (for example, see Patent Literature 4). It is stated that this method can separate the ground product derived from the positive-electrode active material and the carbon derived from the negative-electrode material.

Furthermore, in a proposed method for recycling a secondary battery, for example, a used positive-electrode material is decomposed with an acid, is taken out as a hydroxide, and is regenerated into an oxide again using lithium carbonate (for example, see Non-patent Literature 1). Hydrothermal synthesis using aqueous LiOH/Li₂SO₄, solid phase synthesis using Li₂CO₃, or the addition of mobile Li to an active material by firing have also been proposed in a deactivated LiCoO₂ positive electrode (for example, see Non-patent Literature 2). The addition of mobile Li to an active material using a molten salt containing Li⁺ in a deactivated LiNiCoMnO₂ positive electrode has also been proposed (for example, see Non-patent Literature 3).

### CITATION LIST

### Patent Literature

PTL 1: JP 2021-80491
PTL 2: JP 2020-105599
PTL 3: JP 2019-44246
PTL 4: JP 2020-129505

### Non Patent Literature

Citation 1: Green Chem., 2013, 15, 1183-1191
Citation 2: Green Chem., 2018, 20, 851-862
Citation 3: Adv. Energy Matter, 2019, 9, 1900454

### SUMMARY OF THE INVENTION

In Patent Literature 1 to Patent Literature 4 and Non-patent Literature 1, however, the electrodes are decomposed, and the positive electrode is decomposed into a raw material for synthesis and is resynthesized. Thus, this requires multiple steps. Furthermore, in Non-patent Literature 2, the hydrothermal synthesis and the solid phase synthesis require a process at a high temperature of more than 800° C. Furthermore, in Non-patent Literature 3, it is necessary to decompose the electrode and treat the molten salt at a high temperature, which consumes more energy.

The present disclosure has been made to solve such problems and aims mainly to provide a novel recovery method and a novel recovery system that can more easily perform more appropriate capacity recovery depending on the state of an electrode active material.

As a result of extensive studies to achieve the object, the present inventors have completed the present disclosure by finding that the capacity of an electrode active material can be recovered while decomposing an electrode mixture by immersing an electrode in a predetermined recovery agent and that the capacity of an electrode active material can be recovered without decomposing an electrode mixture by adding an electrolyte solution to the recovery agent.

Thus, a recovery method disclosed herein is a recovery method for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent, the method including: an electrode recovery step of immersing the electrode of the electricity storage device in a recovery agent to recover the capacity of the electrode active material while maintaining the state of the electrode, the recovery agent being a solution containing an aromatic hydrocarbon compound in a reduced state, a metal ion of the same type as the carrier ion, a recovery agent solvent of an ether compound different from the electrolyte solvent, and an electrolyte solvent used for the electrolyte solution.

Another recovery method according to the present disclosure is a recovery method for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent, the method including: a decomposition-recovery step of immersing the electrode of the electricity storage device in a decomposition-recovery agent to recover the capacity of the electrode active material while decomposing the electrode mixture, the decomposition-recovery agent being a solution containing an aromatic hydrocarbon compound in a reduced state, a metal ion of the same type as the carrier ion, and a recovery agent solvent of an ether compound different from the electrolyte solvent, and not containing an electrolyte solvent used for the electrolyte solution.

A recovery system according to the present disclosure is a recovery system for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent, the system including: a recovery section for performing an electrode recovery process of immersing the electrode of the electricity storage device in a recovery agent to recover the capacity of the electrode active material while maintaining the state of the electrode, the recovery agent being a solution containing an aromatic hydrocarbon compound in a reduced state, a metal ion of the same type as the carrier ion, a recovery agent solvent of an ether compound different from the electrolyte solvent, and an electrolyte solvent used for the electrolyte solution.

The present disclosure can more easily perform more appropriate capacity recovery depending on the state of an electrode active material. A plausible reason for such an effect is described below. For example, a treatment solution containing an aromatic hydrocarbon compound in a reduced state containing the same carrier ions as an electricity storage device is a brown liquid or a dark green liquid with different reducing powers depending on whether or not an electrolyte solvent used for an electrolyte solution is added. A treatment solution containing an aromatic hydrocarbon compound in a reduced state and not containing an electrolyte solvent has a high reducing power, can donate an electron and a carrier ion to an electrode active material and thereby recover the capacity of the electrode active material, and can also donate an electron to a fluorinated polymer binder contained in an electrode mixture and thereby promote carbonization and simultaneously reduce binding ability. As a result, this treatment solution functions as a decomposition-recovery agent for recovering the capacity of an electrode active material and decomposing an electrode mixture. On the other hand, a treatment solution containing an aromatic hydrocarbon compound in a reduced state and an electrolyte solvent has a moderate reducing power, does not decompose an electrode mixture, and can recover the capacity of an electrode active material depending on the state of an electrode. Thus, the present disclosure can more easily perform more appropriate capacity recovery depending on the state of an electrode active material by immersing a used electrode in a treatment solution.

### BRIEF DESCRIPTION OF THE DRAWINGS

FIG. 1 is an explanatory view of an example of a recovery system 10.

FIG. 2 is a flow chart of an example of a recovery determination routine.

FIG. 3 is a reaction formula for reduction of a positive electrode.

FIG. 4 is a reaction formula for reduction of a binder.

FIG. 5 is an explanatory view of the blend ratio of three components used for a recovery agent.

FIG. 6 is a graph of the relationship between the square root of the immersion time and the amount of Li in a positive electrode in Experimental Examples 14 and 15.

FIG. 7 is a graph of the relationship between the amount of Li naphthalenide and the Li recovery level.

FIG. 8 is a graph of the relationship between the amount of THF recovery agent and the Li recovery level.

FIG. 9 is a graph of the relationship between the amount of DME recovery agent and the Li recovery level.

### DETAILED DESCRIPTION OF THE INVENTION

(Recovery System)

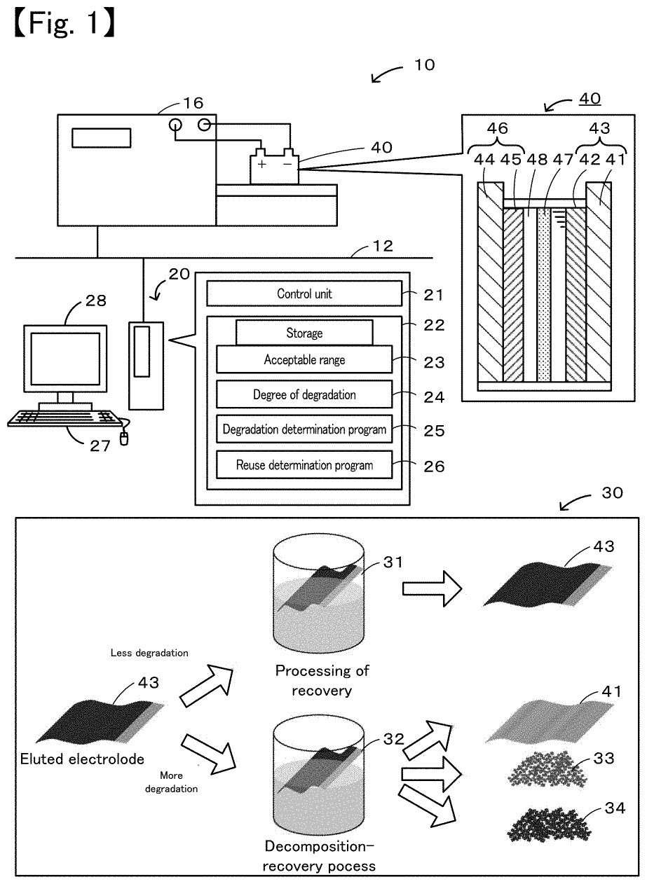

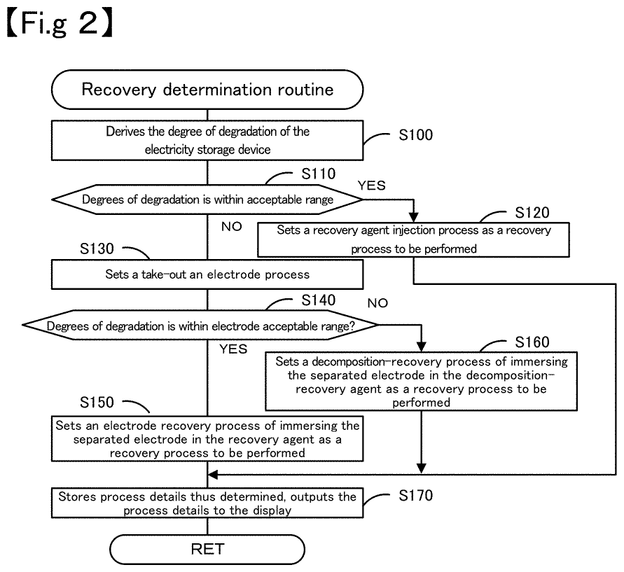

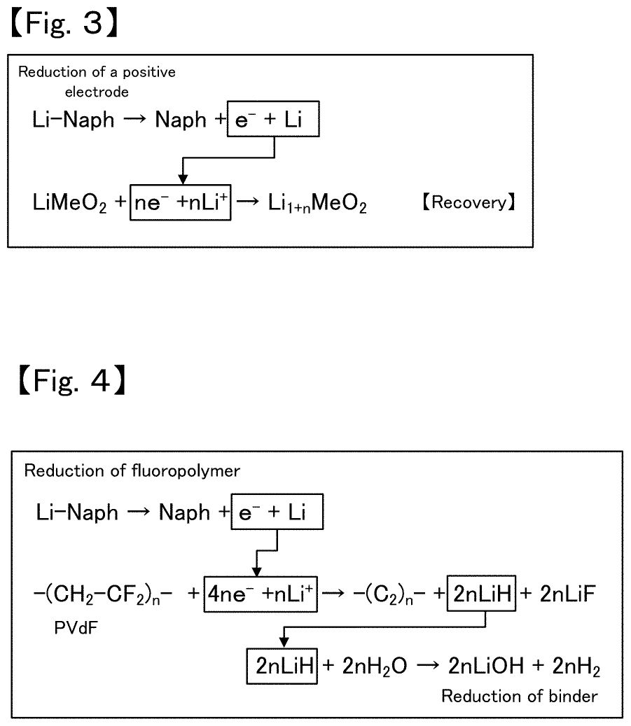

Embodiments of a recovery system 10 disclosed herein are described below with reference to the drawings. FIG. 1 is a schematic explanatory view of an example of the recovery system 10. FIG. 2 is a flow chart of an example of a recovery determination routine. FIG. 3 is a reaction formula for reduction of a positive electrode. FIG. 4 is a reaction formula for reduction of a binder. The recovery system 10 is a system for recovering the capacity of an electrode active material of a used electricity storage device 40 for recycling. The recovery system 10 includes a detector 16, a controller 20, and a recovery section 30. In the recovery system 10, the detector 16 and the controller 20 exchange information via a line 12 including a LAN and the Internet. The recovery system 10 is a system for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent. It is mainly explained herein that the recovery system 10 recovers the capacity of a positive-electrode active material of the electricity storage device 40.

The electricity storage device 40 includes a positive electrode 43 on which a positive-electrode mixture 42 containing a positive-electrode active material is formed, a negative electrode 46 on which a negative-electrode mixture 45 containing a negative-electrode active material is formed, and an electrolyte solution 48 that is in contact with the positive electrode 43 and the negative electrode 46 and that contains a metal ion as a carrier ion and an electrolyte solvent. The electricity storage device 40 is, for example, a hybrid capacitor, a pseudo-electric double layer capacitor, an alkali metal (lithium or sodium) secondary battery, an alkali metal ion battery, or an air battery. A metal ion serving as a carrier ion is, for example, an alkali metal ion, such as Li, Na, or K, or a group 2 ion (an alkaline-earth metal ion), such as Mg, Ca, or Sr. Among these, a lithium ion is preferred. The electricity storage device 40 is preferably a lithium secondary battery, particularly a lithium-ion secondary battery. The electricity storage device 40 is mainly described herein on the assumption that it is a lithium secondary battery. For example, the electricity storage device 40 may include a positive electrode 43 having a positive-electrode active material for intercalating and deintercalating lithium ions, a negative electrode 46 having a negative-electrode active material for intercalating and deintercalating lithium ions, and an electrolyte solution 48 that is located between the positive electrode 43 and the negative electrode 46 and transfers lithium ions. The electricity storage device 40 may include a separator 47 between the positive electrode 43 and the negative electrode 46. The positive electrode 43 may have the positive-electrode mixture 42 formed on the surface of a current collector 41. The positive-electrode mixture 42 may contain an electrically conductive material, a binder, and the like in addition to the positive-electrode active material. The positive-electrode active material is, for example, a compound containing lithium and a transition metal element, preferably an oxide containing lithium and a transition metal element. The positive-electrode active material may be, for example, a lithium manganese composite oxide represented by a basic composition formula Li₍₁₋ₓ₎MnO₂ (0<x<1, the same applies to the following) or Li₍₁₋ₓ₎Mn₂O₄, a lithium cobalt composite oxide represented by a basic composition formula Li₍₁₋ₓ₎CoO₂, a lithium nickel composite oxide represented by a basic composition formula Li₍₁₋ₓ₎NiO₂, or a lithium nickel cobalt manganese composite oxide represented by a basic composition formula Li₍₁₋ₓ₎NiₐCo_{b}Mn_{c}O₂ (a+b+c=1). The positive-electrode active material may also be lithium iron phosphate. The term “basic composition formula” means that another element may be contained. The negative electrode 46 may have the negative-electrode mixture 45 formed on the surface of a current collector 44. The negative-electrode mixture 45 may contain an electrically conductive material, a binder, and the like in addition to the negative-electrode active material. The negative-electrode active material is, for example, lithium, a lithium alloy, an inorganic compound, such as a tin compound, a carbon material capable of intercalating and deintercalating lithium ions, a composite oxide containing a plurality of elements, or an electrically conductive polymer. The carbon material is, for example, coke, glassy carbon, graphite, non-graphitizable carbon, pyrolytic carbon, or carbon fiber. Among these, graphite, such as artificial graphite or natural graphite, is preferred. The composite oxide is, for example, a lithium titanium composite oxide or a lithium vanadium composite oxide. The electrolyte solution 48 may be, for example, an electrolyte solution in which a supporting salt is dissolved. The supporting salt is, for example, a lithium salt, such as LiPF₆ or LiBF₄. The electrolyte solvent is, for example, carbonate, ester, ether, nitrile, furan, sulfolane, or dioxolane, which may be used alone or in combination. Specific examples of the carbonate include cyclic carbonates, such as ethylene carbonate (EC), propylene carbonate (PC), vinylene carbonate (VC), butylene carbonate, and chloroethylene carbonate, and chain carbonates, such as dimethyl carbonate (DMC), ethyl methyl carbonate (EMC), diethyl carbonate, ethyl-n-butyl carbonate, methyl-t-butyl carbonate, di-i-propyl carbonate, and t-butyl-1-propyl carbonate. The electrolyte solution 48 may be a solid ion-conducting polymer, an inorganic solid electrolyte, a mixed material of an organic polymer electrolyte and an inorganic solid electrolyte, or an inorganic solid powder bound by an organic binder. The electrolyte solvent in the electrolyte solution 48 may be different from a recovery agent solvent of a recovery agent 31 or a decomposition-recovery agent 32 described later. The current collectors 41 and 44 may be, for example, at least one of aluminum, titanium, stainless steel, nickel, iron, copper, baked carbon, an electrically conductive polymer, electrically conductive glass, and the like. The separator 47 is, for example, a polymer nonwoven fabric, such as a polypropylene nonwoven fabric or a poly(phenylene sulfide) nonwoven fabric, or a thin microporous membrane of an olefin resin, such as polyethylene or polypropylene.

The detector 16 is electrically connected to the electricity storage device 40, measures the charge-discharge characteristics of the electricity storage device 40, and derives the degree of degradation of the electricity storage device 40. The degree of degradation can be defined, for example, by the ratio of the capacity after degradation to the initial capacity. For example, the detector 16 can measure the alternating-current impedance as well as the charge-discharge capacity and estimate the degree of degradation on the basis of the alternating-current impedance.

The controller 20 is a computer that controls the entire recovery system 10. The controller 20 includes a control unit 21, a storage 22, an input device 27, and a display 28. The control unit 21 is configured as a microprocessor centered on a CPU and controls the entire apparatus. The control unit 21 outputs a measurement start command to the detector 16 and inputs the measurement results from the detector 16. The control unit 21 executes a reuse determination program 26 and thereby performs determination processing regarding a recycling system of the electricity storage device 40. The input device 27 includes a mouse, a keyboard, and the like to perform various inputs. The display 28 has a screen and is a liquid crystal display, for example.

The storage 22 is configured, for example, as a mass storage, such as a HDD, and stores the acceptable range 23, information on the degree of degradation 24, a degradation determination program 25, and the reuse determination program 26. The acceptable range 23 is a threshold used to determine a reuse method from the degradation state of the electricity storage device 40. The acceptable range 23 includes, for example, a threshold of a battery acceptable range to determine whether to recover the capacity of an electrode active material directly from the electricity storage device 40 or to recover the capacity from an electrode after disassembling, or a threshold of an electrode acceptable range to determine whether to recover the capacity of an electrode active material directly from an electrode or to recover the capacity of an electrode active material by decomposing an electrode mixture. The battery acceptable range may be empirically determined, for example, in the range of the degree of degradation that can be sufficiently recovered and reused in the state of the electricity storage device 40. The electrode acceptable range may be empirically determined, for example, in the range below the battery acceptable range and in the range of the degree of degradation that can be sufficiently recovered and reused in the state of an electrode of the electricity storage device 40. More specifically, the battery acceptable range may be in the range of the degree of degradation below 40%, and the electrode acceptable range may be in the range of the degree of degradation of 60% or less. The information on the degree of degradation 24 is information including the degree of degradation of the electricity storage device 40 measured by the detector 16 and is acquired from the detector 16 via the line 12. The degradation determination program 25 is a program for deriving the degree of degradation from the measurement results of the detector 16. The reuse determination program 26 is a program for determining the contents of recycling of the electricity storage device 40 and includes a recovery determination routine illustrated in FIG. 2.

The recovery section 30 is equipment or an apparatus for recovering the capacity of an electrode of the electricity storage device 40. The recovery section 30 performs an electrode recovery process of immersing an electrode in the recovery agent 31 to recover the capacity of an electrode active material while maintaining the state of the electrode or performs a decomposition-recovery process of immersing an electrode of the electricity storage device in the decomposition-recovery agent 32 to recover the capacity of an electrode active material while decomposing an electrode mixture. The recovery agent 31 is a solution containing an aromatic hydrocarbon compound in a reduced state, a metal ion of the same type as the carrier ion, a recovery agent solvent of an ether compound different from the electrolyte solvent, and an electrolyte solvent used for the electrolyte solution. The decomposition-recovery agent 32 is a solution containing an aromatic hydrocarbon compound in a reduced state, a metal ion of the same type as the carrier ion, and a recovery agent solvent of an ether compound different from the electrolyte solvent, and not containing an electrolyte solvent used for the electrolyte solution. For convenience of description, the recovery agent 31 and the decomposition-recovery agent 32 are also collectively referred to as a treatment solution.

The recovery agent 31 and the decomposition-recovery agent 32 (treatment solution) used in the recovery section 30 contain an aromatic hydrocarbon compound in a reduced state and a metal ion. The treatment solution may contain an aromatic hydrocarbon compound represented by at least one of the following formulae (1) and (2). The treatment solution may be prepared by at least one of the following formulae (3) and (4). More specifically, an aromatic hydrocarbon compound is reacted with a metal to contain an aromatic hydrocarbon compound in a reduced state and a metal ion. The recovery agent solvent may be dimethyl ether (DME) instead of tetrahydrofuran (THF). The metal preferably has high reactivity so as to react with the aromatic hydrocarbon compound and is preferably an alkali metal or a metal of a group 2 element. The treatment solution may contain an aromatic hydrocarbon compound that is at least one of naphthalene, biphenyl, o-terphenyl, anthracene, and p-terphenyl. The aromatic hydrocarbon compound is preferably naphthalene or biphenyl. The treatment solution may contain a metal ion that is at least one of a lithium ion, a sodium ion, and a potassium ion. Among these metal ions, a lithium ion is more preferred.

Furthermore, the treatment solution contains, as the recovery agent solvent, an ether compound different from the electrolyte solvent. The recovery agent solvent may be, for example, a cyclic ether compound or a chain ether compound. The recovery agent solvent may be at least one of tetrahydrofuran (THF), dioxolane, dioxane, dimethyl ether (DME), diethyl ether (DEE), dimethoxyethane (G1), diglyme (G2), triglyme (G3), and tetraglyme (G4). Among these, THF and DME are preferred, and THF is more preferred. For example, as shown in the formula (5) to (7), the treatment solution is preferably prepared by a reaction of one of naphthalene, biphenyl, and o-terphenyl with Li metal in a solvent THF. The use of such a treatment solution facilitates the recovery of an electrode active material. The use of such a treatment solution as the decomposition-recovery agent 32 facilitates the decomposition of an electrode mixture and is preferred. The electrolyte solvent may be the same as or different from the electrolyte solvent of the electricity storage device 40. The electrolyte solvent may be a carbonate compound. The electrolyte solvent is, for example, a cyclic carbonate or a chain carbonate described above. The electrolyte solvent may be contained in the treatment solution as an electrolyte solution containing a supporting salt. The supporting salt may be any one of those described for the electricity storage device 40.

Furthermore, in the treatment solution, the recovery agent may be a mixed solution of a THF recovery agent containing an aromatic hydrocarbon compound in a reduced state and a metal ion in a solvent THF and a DME recovery agent containing an aromatic hydrocarbon compound in a reduced state and a metal ion in a solvent DME. Furthermore, the decomposition-recovery agent may be a mixed solution of the THF recovery agent, the DME recovery agent, and an electrolyte solvent. In the treatment solution, the blend ratio of the THF recovery agent preferably ranges from 20% to 80% by volume, preferably 30% or more by volume, and may be 50% or more by volume. In the treatment solution, the blend ratio of the DME recovery agent preferably ranges from 20% to 80% by volume, preferably 30% or more by volume, and may be 50% or more by volume. Furthermore, in the treatment solution, the blend ratio of the electrolyte solvent preferably ranges from 10% to 50% by volume, more preferably 20% to 40% by volume, and may be 30% or less by volume. When the electrolyte solvent is 10% or more by volume, the treatment solution has lower reducibility, and an electrode mixture is less likely to be decomposed. Furthermore, when the electrolyte solvent is 10% or more by volume, the amount of aromatic hydrocarbon compound in a reduced state is relatively increased, and the electrode active material can be more reliably recovered. In the treatment solution, the mixing ratio T/D of the THF recovery agent (T) to the DME recovery agent (D) is, for example, preferably in the range of 1 to 5, more preferably 1.5 to 4, in terms of volume ratio. In the treatment solution, the concentration of an aromatic hydrocarbon compound in a reduced state with respect to the entire treatment solution preferably ranges from 0.1 to 3 mol/L, more preferably 0.5 mol/L or more, still more preferably 1 mol/L or more. At a higher concentration, an electrode active material can be more reliably recovered.

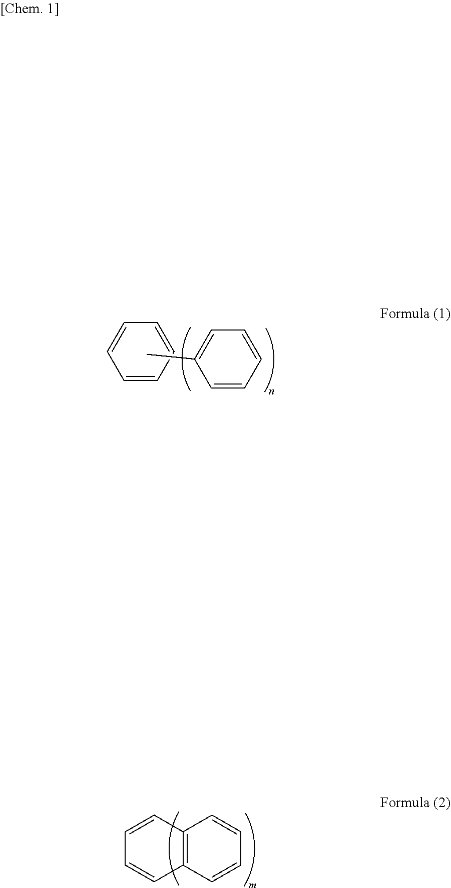

However, n is an integer of 1 or more and 4 or less, and m is an integer of 1 or more and 4 or less.

The aromatic ring may have a substituent or a heteroatom in its structure.

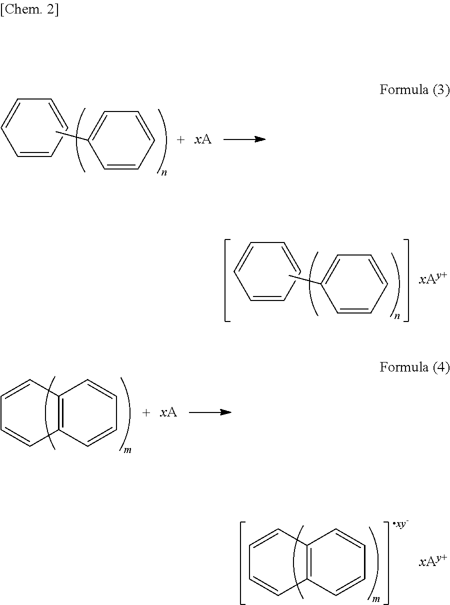

However, n is an integer of 1 or more and 4 or less, and m is an integer of 1 or more and 4 or less.

The aromatic ring may have a substituent or a heteroatom in its structure. x and y are arbitrary numbers, and A is a metal.

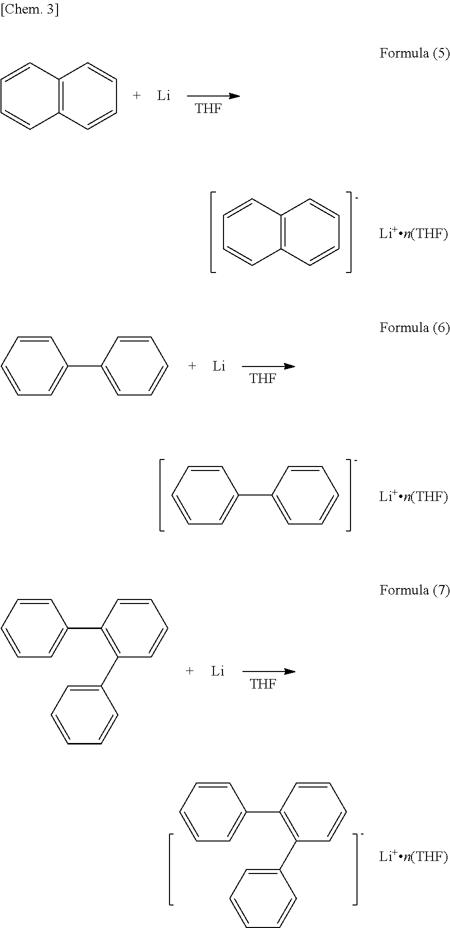

In the recovery section 30, an electrode of the electricity storage device 40 is immersed in the treatment solution at any temperature, which may range from 10° C. to 60° C. or 20° C. to 40° C. The recovery temperature of the electrode is preferably near room temperature (20° C. to 25° C.) The immersion time of the electrode in the recovery section 30 may depend on the recovery state of the electrode and is, for example, preferably 10 minutes or more, preferably 30 minutes or more. The immersion time is preferably 24 hours or less, more preferably 12 hours or less, and may be 8 hours or less. When the degree of degradation of the electricity storage device 40 is within a predetermined electrode acceptable range, the recovery section 30 performs an electrode recovery process on an electrode of the electricity storage device 40, and when the degree of degradation of the electricity storage device 40 is outside the electrode acceptable range, the recovery section 30 performs a decomposition-recovery process on an electrode of the electricity storage device 40. The recovery process may be performed by an operator or may be automatically performed by the apparatus.

(Recovery Method)

The following describes the operation of the recovery system 10 according to the present embodiment configured as described above, in particular, the recovery process performed by the controller 20. First, the recovery determination routine illustrated in FIG. 2 is described. This routine is included in the reuse determination program 26 stored in the storage 22 and is performed by the control unit 21 as the operator performs the routine. When the routine is performed, the control unit 21 first acquires the degree of degradation of the electricity storage device 40 from the detector 16 (S100). The operator connects a used electricity storage device 40 to the detector 16 in advance. Receiving a measurement start command from the control unit 21, the detector 16 measures the degree of degradation of the electricity storage device 40 and outputs the measurement results to the control unit 21. The control unit 21 may acquire the degree of degradation of the electricity storage device 40 by using the measurement results and the degradation determination program 25.

Next, the control unit 21 determines whether or not the degree of degradation of the electricity storage device 40 is within the battery acceptable range (S110), and if the degree of degradation is within the battery acceptable range, sets a recovery agent injection process as a recovery process to be performed (S120). The control unit 21 uses the battery acceptable range set as the acceptable range 23. The recovery agent injection process is a process of injecting a small amount of recovery agent into the electricity storage device 40 to recover the electrode active material directly in the cell. This process is not described in detail in the present disclosure. On the other hand, if the degree of degradation is outside the battery acceptable range, the control unit 21 sets a take-out process of disassembling the electricity storage device 40 and taking out an electrode (S130) and determines whether or not the degree of degradation is within the electrode acceptable range (S140). The control unit 21 uses the electrode acceptable range set as the acceptable range 23. If the degree of degradation is within the electrode acceptable range, the control unit 21 sets an electrode recovery process of immersing the separated electrode in the recovery agent as a recovery process to be performed (S150). On the other hand, if the degree of degradation is outside the electrode acceptable range in S140, the control unit 21 sets a decomposition-recovery process of immersing the separated electrode in the decomposition-recovery agent as a recovery process to be performed (S160). After S150, S160, or S120, the control unit 21 stores process details thus determined, outputs the process details to the display 28 (S170), and ends the routine. The operator confirms the process details and performs the process of the electricity storage device 40 in the recovery section 30.

The electrode recovery process includes a process of immersing an electrode of the electricity storage device 40 in a recovery agent to recover the capacity of an electrode active material while maintaining the state of the electrode, the recovery agent being a solution containing an aromatic hydrocarbon compound in a reduced state, a metal ion of the same type as the carrier ion, a recovery agent solvent of an ether compound different from the electrolyte solvent, and an electrolyte solvent used for the electrolyte solution. The process conditions may be appropriately selected from the conditions described above. For example, immersing the positive electrode 43 in the recovery agent 31 promotes reactions as illustrated in FIG. 3 and recovers the charge-discharge activity of the positive-electrode active material. The positive electrode 43 after the recovery process can be reused as it is for the electricity storage device 40.

The decomposition-recovery process includes a process of immersing an electrode of the electricity storage device 40 in a decomposition-recovery agent to recover the capacity of an electrode active material while decomposing an electrode mixture, the decomposition-recovery agent being a solution containing an aromatic hydrocarbon compound in a reduced state, a metal ion of the same type as the carrier ion, and a recovery agent solvent of an ether compound different from the electrolyte solvent, and not containing an electrolyte solvent used for the electrolyte solution. The process conditions may be appropriately selected from the conditions described above. For example, immersing the positive electrode 43 in the decomposition-recovery agent 32 promotes reactions as illustrated in FIG. 3 and recovers the charge-discharge activity of the positive-electrode active material. Furthermore, the decomposition-recovery agent 32 promotes reactions as illustrated in FIG. 4, reduces the binding ability of a binder contained in the positive-electrode mixture 42, and decomposes the positive-electrode mixture 42 into the current collector 41, a positive-electrode active material 33, and a mixture member 34. The mixture member 34 contains components of an electrically conductive material, a binder, and the like other than the positive-electrode active material 33. In the recovery process, the current collector 41 and the mixture member 34 can be reused as members, and the recovered positive-electrode active material 33 can also be reused as it is as a member.

The recovery system 10 and the recovery method according to the present embodiment can more easily perform more appropriate capacity recovery depending on the state of an electrode active material. A plausible reason for such an effect is described below. For example, a recovery agent containing an aromatic hydrocarbon compound in a reduced state containing the same carrier ions as the electricity storage device 40 is a brown liquid or a dark green liquid with different reducing powers depending on whether or not an electrolyte solvent used for an electrolyte solution is added. A treatment solution containing an aromatic hydrocarbon compound in a reduced state and not containing an electrolyte solvent has a high reducing power, can donate an electron and a carrier ion to an electrode active material and thereby recover the capacity of the electrode active material, and can also donate an electron to a fluorinated polymer binder contained in an electrode mixture and thereby promote carbonization and simultaneously reduce binding ability. As a result, this treatment solution functions as a decomposition-recovery agent for recovering the capacity of an electrode active material and decomposing an electrode mixture. On the other hand, a treatment solution containing an aromatic hydrocarbon compound in a reduced state and an electrolyte solvent has a moderate reducing power, does not decompose an electrode mixture, and can recover the capacity of an electrode active material depending on the state of an electrode. Thus, the present disclosure can more easily perform more appropriate capacity recovery depending on the state of an electrode active material by immersing a used electrode in a treatment solution.

It goes without saying that the present disclosure should not be limited to these embodiments and can be implemented in various aspects within the technical scope of the present disclosure.

### Examples

The following describes, as experimental examples, examples in which a recovery method and a recovery system according to the present disclosure are specifically studied. Experimental Examples 1 to 24 correspond to examples of the present disclosure, and Experimental Example 25 corresponds to a comparative example.

(Preparation of Electricity Storage Device)

In a positive electrode, a positive-electrode mixture containing 92% by mass of LiNi_{1/3}Co_{1/3}Mn_{1/3}O₂ (NCM manufactured by Toda Kogyo Corp.) as a positive-electrode active material, 5% by mass of acetylene black (manufactured by Denka Company Limited) as an electrically conductive material, and 3% by mass of poly (vinylidene difluoride) (manufactured by Kureha Corporation) as a binder was applied to one surface of an aluminum current collector foil at a mass per unit area of 7 mg/cm². Li metal was used for a negative electrode. An electrolyte solution contained 1.1 M LiPF₆ dissolved in a mixed solvent containing 30% by volume of ethylene carbonate (EC), 40% by volume of dimethyl carbonate (DMC), and 30% by volume of ethyl methyl carbonate (EMC). A polypropylene separator impregnated with 1 mL of the electrolyte solution was placed between the positive electrode and the negative electrode to prepare a laminate cell. This was used as a pre-degradation cell. The positive electrode and the negative electrode of the cell had an electrode area of 10 cm².

(Degraded Cell)

The laminate cell was charged to a capacity corresponding to 50% of the electric capacity of the cell in the voltage range of 3.0 to 4.1 V (SOC=50%), thereby extracting Li from the positive electrode to prepare a positive electrode with a reduced capacity in a simulated manner (hereinafter also referred to as a degraded positive electrode). The cell was then disassembled, and the degraded positive electrode was taken out. A laminate cell was prepared in the same manner as in the preparation of the pre-degradation cell except that the degraded positive electrode was used as the positive electrode. This was used as a degraded cell.

(Recovery Agent)

Naphthalene was dissolved at 1.0 mol/L in a tetrahydrofuran (THF) solvent in an inert atmosphere, and then 1.0 mol/L of lithium metal was added and stirred to prepare a dark green radical anion liquid composition (THF recovery agent) as a recovery agent stock solution by a reaction represented by the formula (7). A DME recovery agent was prepared in the same manner using a dimethoxyethane (DME) solvent instead of the THF solvent. The three components of the THF recovery agent, the DME recovery agent, and the electrolyte solution were mixed at a volume ratio shown in Table 1 to prepare a recovery agent.

(Recovery Process)

The electrode in a charged state was immersed in a solution of the recovery agent with the composition shown in Table 1 at 20° C. for 30 minutes, and then the state of the electrode and the amount of Li in the positive electrode were examined. The amount of Li was measured by ICP spectroscopy.

(Results and Discussion)

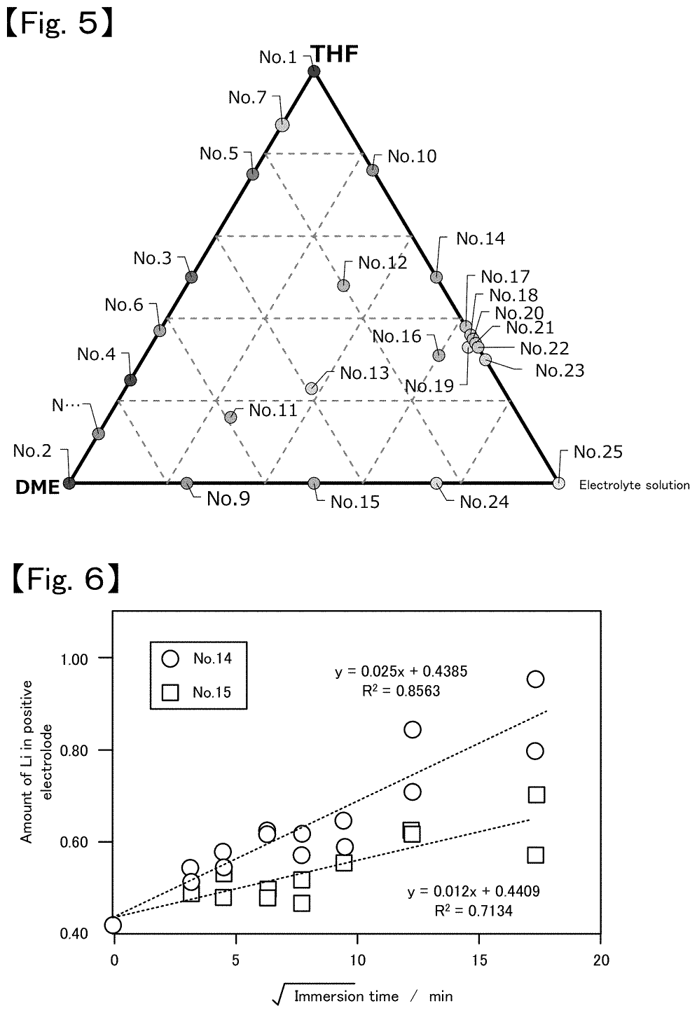

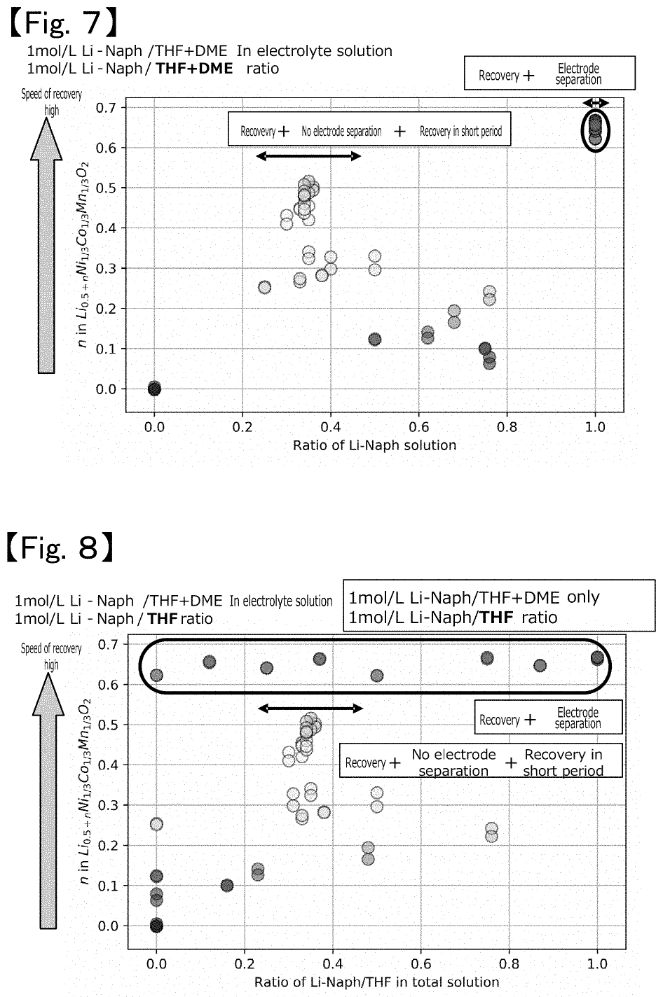

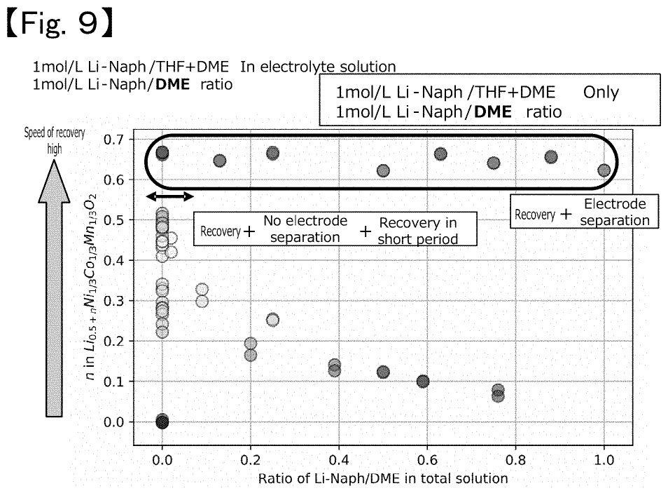

Table 1 summarizes the blend ratio of each recovery agent, the amount of Li increase, and the state of the electrode after recovery in Experimental Examples 1 to 25. In Table 1, each sample was measured multiple times, and the resulting values were averaged. FIG. 5 is an explanatory view of the blend ratio of the three components used for the recovery agent. FIG. 6 is a graph of the relationship between the square root of the immersion time and the amount of Li in the positive electrode in Experimental Examples 14 and 15. FIG. 7 is a graph of the relationship between the amount of Li naphthalenide and the Li recovery level. FIG. 8 is a graph of the relationship between the amount of THF recovery agent and the Li recovery level. FIG. 9 is a graph of the relationship between the amount of DME recovery agent and the Li recovery level. As illustrated in FIG. 6, immersing the charged positive electrode in the recovery agent linearly increases the amount of Li with respect to the square root of the immersion time. Thus, it was found that the Li recovery level could be controlled via the immersion time in a recovery agent containing an aromatic hydrocarbon compound in a sufficiently reduced state.

Table 1 and FIGS. 7 to 9 show that immersing the electrode in the recovery agent increases the amount of Li in the positive-electrode active material and recovers the positive-electrode active material. As illustrated in FIG. 3, this is probably because lithium naphthalenide donates electrons and Li ions to the positive-electrode active material, that is, a lithium composite oxide. With the recovery agents not containing the electrolyte solution in Experimental Examples 1 to 8, the electrode mixture was separated from the current collector. By contrast, in Experimental Examples 9 to 24 containing the electrolyte solution, the electrode mixture was not separated from the current collector. This is probably because, for example, a recovery agent containing an aromatic hydrocarbon compound in a reduced state having a Li ion is a brown liquid or a dark green liquid with different reducing powers depending on whether or not the electrolyte solution is added. It was also surmised that the solution containing the aromatic hydrocarbon compound in a reduced state and not containing the electrolyte solution had a high reducing power and could recover the capacity, and, as illustrated in FIG. 4, could donate an electron to the fluorinated polymer binder contained in the electrode mixture and thereby promoted carbonization and simultaneously reduced binding ability. As a result, it was found that this solution functioned as a decomposition-recovery agent for recovering the capacity of an electrode active material and decomposing an electrode mixture. On the other hand, a solution containing an aromatic hydrocarbon compound in a reduced state and an electrolyte solution had a moderate reducing power, did not decompose an electrode mixture, and could recover the capacity of an electrode active material depending on the state of an electrode. Thus, it was found that the present examples could more easily perform more appropriate capacity recovery depending on the state of an electrode active material by immersing a used electrode in a recovery agent or a decomposition-recovery agent.

As illustrated in FIGS. 7 to 9, when an electrode was immersed in a recovery agent to recover an electrode active material, it was surmised that THF was better than DME as a recovery agent solvent. This is because the relationship between the amount of THF recovery agent and the amount of Li increase is not clear in FIG. 8 in which the horizontal axis is based on the THF recovery agent, but the amount of Li increase tends to decrease as the blend ratio of the DME recovery agent increases in FIG. 9 in which the horizontal axis is based on the DME recovery agent. It was also surmised that the concentration of an aromatic hydrocarbon compound in a reduced state preferably ranged from 0.1 to 3 mol/L.

TABLE 1

| | Treatment solution composition | | | | Li Containing | Li Containing | Amount | |
|---|---|---|---|---|---|---|---|---|
| | | | Electrolyte | THF + | rate before | rate after | of Li | |
| | THF | DME | solution | DME | processing | processing | increase | Status after |
| | Ratio | Ratio | Ratio | Ratio | mol % | mol % | mol | processing |
| Experimental Example 1 | 1.00 | 0.00 | 0.00 | 1.00 | 0.469 | 1.135 | 0.665 | Separated |
| Experimental Example 2 | 0.00 | 1.00 | 0.00 | 1.00 | 0.510 | 1.132 | 0.623 | Separated |
| Experimental Example 3 | 0.50 | 0.50 | 0.00 | 1.00 | 0.510 | 1.131 | 0.622 | Separated |
| Experimental Example 4 | 0.25 | 0.75 | 0.00 | 1.00 | 0.491 | 1.132 | 0.641 | Separated |
| Experimental Example 5 | 0.75 | 0.25 | 0.00 | 1.00 | 0.466 | 1.131 | 0.665 | Separated |
| Experimental Example 6 | 0.37 | 0.63 | 0.00 | 1.00 | 0.469 | 1.132 | 0.663 | Separated |
| Experimental Example 7 | 0.87 | 0.13 | 0.00 | 1.00 | 0.484 | 1.131 | 0.647 | Separated |
| Experimental Example 8 | 0.12 | 0.88 | 0.00 | 1.00 | 0.478 | 1.134 | 0.656 | Separated |
| Experimental Example 9 | 0.00 | 0.76 | 0.24 | 0.76 | 0.480 | 0.551 | 0.071 | Not Separated |
| Experimental Example 10 | 0.76 | 0.00 | 0.24 | 0.76 | 0.473 | 0.706 | 0.232 | Not Separated |
| Experimental Example 11 | 0.16 | 0.59 | 0.25 | 0.75 | 0.492 | 0.592 | 0.100 | Not Separated |
| Experimental Example 12 | 0.48 | 0.20 | 0.32 | 0.68 | 0.481 | 0.661 | 0.180 | Not Separated |
| Experimental Example 13 | 0.23 | 0.39 | 0.38 | 0.62 | 0.470 | 0.605 | 0.134 | Not Separated |
| Experimental Example 14 | 0.50 | 0.00 | 0.50 | 0.50 | 0.544 | 0.857 | 0.317 | Not Separated |
| Experimental Example 15 | 0.00 | 0.50 | 0.50 | 0.50 | 0.498 | 0.621 | 0.123 | Not Separated |
| Experimental Example 16 | 0.31 | 0.09 | 0.60 | 0.40 | 0.510 | 0.822 | 0.315 | Nat Separated |
| Experimental Example 17 | 0.38 | 0.00 | 0.62 | 0.38 | 0.466 | 0.748 | 0.282 | Not Separated |
| Experimental Example 18 | 0.36 | 0.00 | 0.64 | 0.36 | 0.491 | 0.989 | 0.498 | Not Separated |
| Experimental Example 19 | 0.33 | 0.02 | 0.65 | 0.35 | 0.481 | 0.917 | 0.437 | Not Separated |
| Experimental Example 20 | 0.35 | 0.00 | 0.65 | 0.35 | 0.477 | 0.894 | 0.417 | Not Separated |
| Experimental Example 21 | 0.34 | 0.00 | 0.66 | 0.34 | 0.481 | 0.954 | 0.473 | Not Separated |
| Experimental Example 22 | 0.33 | 0.00 | 0.67 | 0.33 | 0.478 | 0.836 | 0.359 | Not Separated |
| Experimental Example 23 | 0.30 | 0.00 | 0.70 | 0.30 | 0.510 | 0.930 | 0.425 | Not Separated |
| Experimental Example 24 | 0.00 | 0.25 | 0.75 | 0.25 | 0.486 | 0.738 | 0.253 | Not Separated |
| Experimental Example 25 | 0.00 | 0.00 | 1.00 | 0.00 | 0.465 | 0.466 | −0.003 | Not Separated |

It goes without saying that the present disclosure should not be limited to these examples and can be implemented in various aspects within the technical scope of the present disclosure.

This specification refers to Japanese Patent Application No. 2021-137686, filed in Japan on Aug. 26, 2021, the disclosure of which, including the specification, the drawings and the claims, is incorporated herein in its entirety.

What is claimed is:

1. A recovery method for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent, the method comprising:
an electrode recovery step of immersing the electrode of the electricity storage device in a recovery agent to recover the capacity of the electrode active material while maintaining the state of the electrode, the recovery agent being a solution containing an aromatic hydrocarbon compound in a reduced state, a metal ion of the same type as the carrier ion, a recovery agent solvent of an ether compound different from the electrolyte solvent, and an electrolyte solvent used for the electrolyte solution.

2. The recovery method according to claim 1, comprising:
in addition to or instead of the electrode recovery step, a decomposition-recovery step of immersing the electrode of the electricity storage device in a decomposition-recovery agent to recover the capacity of the electrode active material while decomposing the electrode mixture, the decomposition-recovery agent being a solution containing an aromatic hydrocarbon compound in a reduced state, a metal ion of the same type as the carrier ion, and a recovery agent solvent of an ether compound different from the electrolyte solvent, and not containing an electrolyte solvent used for the electrolyte solution.

3. The recovery method according to claim 2, comprising:
a degradation acquiring step of acquiring a degree of degradation of an electrode of the electricity storage device,
wherein the electrode recovery step is performed on the electrode of the electricity storage device when the degree of degradation is within a predetermined acceptable range, and the decomposition-recovery step is performed on the electrode of the electricity storage device when the degree of degradation is outside the acceptable range.

4. A recovery method for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent, the method comprising:
a decomposition-recovery step of immersing the electrode of the electricity storage device in a decomposition-recovery agent to recover the capacity of the electrode active material while decomposing the electrode mixture, the decomposition-recovery agent being a solution containing an aromatic hydrocarbon compound in a reduced state, a metal ion of the same type as the carrier ion, and a recovery agent solvent of an ether compound different from the electrolyte solvent, and not containing an electrolyte solvent used for the electrolyte solution.

5. The recovery method according to claim 1, wherein the recovery agent solvent contains at least one of tetrahydrofuran (THF), dimethyl ether (DME), diethyl ether (DEE), diglyme (G2), triglyme (G3), and tetraglyme (G4).

6. The recovery method according to claim 1, wherein the electrolyte solvent is a carbonate compound.

7. The recovery method according to claim 1, wherein the aromatic hydrocarbon compound is at least one of the compounds represented by the formula (1) and (2). 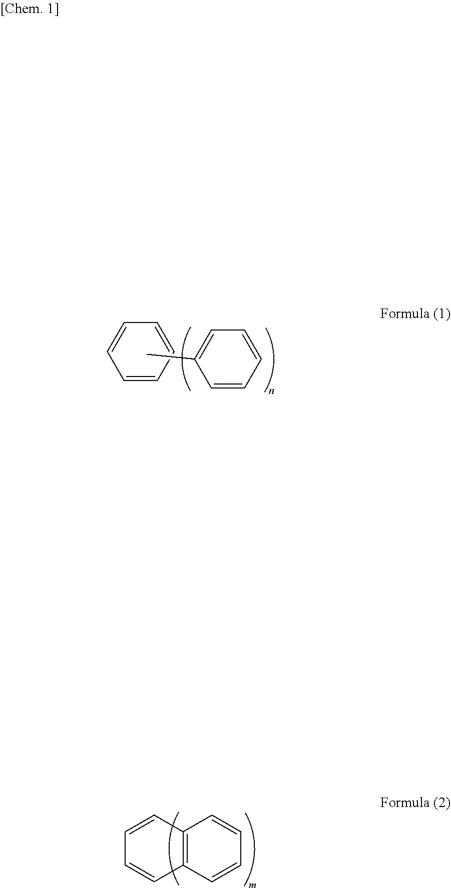
However, n is an integer of 1 or more and 4 or less, and m is an integer of 1 or more and 4 or less.
The aromatic ring may have a substituent or a heteroatom in its structure.

8. The recovery method according to claim 1, wherein the aromatic hydrocarbon compound in the reduced state is in a concentration range of 0.1 to 3 mol/L.

9. The recovery method according to claim 1, wherein the electrode active material is a lithium transition metal composite compound.

10. A recovery system for recovering the capacity of an electrode active material of an electricity storage device having an electrode on which an electrode mixture containing the electrode active material is formed and containing an electrolyte solution that is in contact with the electrode and that contains a metal ion as a carrier ion and an electrolyte solvent, the system comprising:
a recovery section for performing an electrode recovery process of immersing the electrode of the electricity storage device in a recovery agent to recover the capacity of the electrode active material while maintaining the state of the electrode, the recovery agent being a solution containing an aromatic hydrocarbon compound in a reduced state, a metal ion of the same type as the carrier ion, a recovery agent solvent of an ether compound different from the electrolyte solvent, and an electrolyte solvent used for the electrolyte solution.

11. The recovery system according to claim 10, wherein in addition to or instead of the electrode recovery process, the recovery section performs a decomposition-recovery process of immersing the electrode of the electricity storage device in a decomposition-recovery agent to recover the capacity of the electrode active material while decomposing the electrode mixture, the decomposition-recovery agent being a solution containing an aromatic hydrocarbon compound in a reduced state, a metal ion of the same type as the carrier ion, and a recovery agent solvent of an ether compound different from the electrolyte solvent, and not containing an electrolyte solvent used for the electrolyte solution.

12. The recovery system according to claim 11, comprising:
a degradation acquisition section for acquiring a degree of degradation of the electrode of the electricity storage device,
the recovery section performs the electrode recovery process on the electrode of the electricity storage device when the degree of degradation is within a predetermined acceptable range, and performs the decomposition-recovery process on the electrode of the electricity storage device when the degree of degradation is outside the acceptable range.

13. The recovery system according to claim 10, wherein the recovery agent solvent contains at least one of tetrahydrofuran (THF), dimethyl ether (DME), diethyl ether (DEE), diglyme (G2), triglyme (G3), and tetraglyme (G4).

14. The recovery system according to claim 10, wherein the electrolyte solvent is a carbonate compound.

15. The recovery system according to claim 10, wherein the aromatic hydrocarbon compound is at least one of the compounds represented by the formulae (1) and (2). 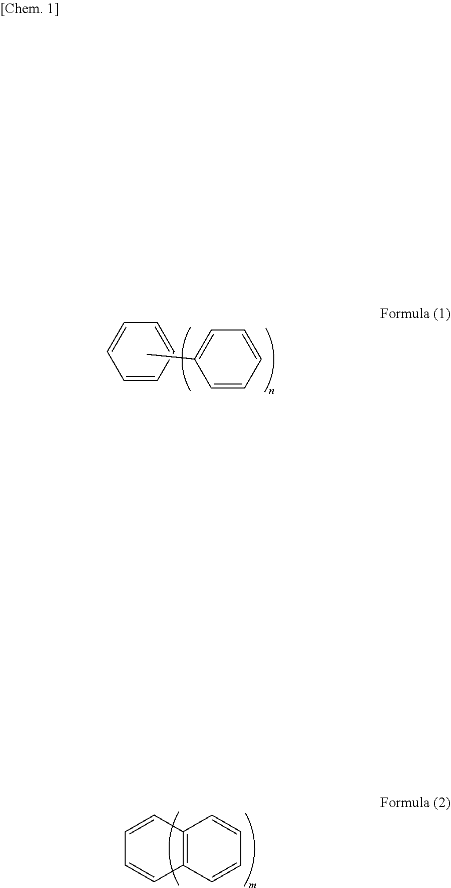
However, n is an integer of 1 or more and 4 or less, and m is an integer of 1 or more and 4 or less.
The aromatic ring may have a substituent or a heteroatom in its structure.

16. The recovery system according to claim 10, wherein the aromatic hydrocarbon compound in the reduced state is in a concentration range of 0.1 to 3 mol/L.

17. The recovery system according to claim 10, wherein the electrode active material is a lithium transition metal composite compound.
